(19) United States
(12) Patent Application Publication
(10) Pub. No.: US 2024/0250467 A1
(43) Pub. Date: Jul. 25, 2024

(54) Electrical Connector With Integrated Touch Protection

(71) Applicant: Lear Corporation, Southfield, MI (US)

(72) Inventors: Michael Kaiser, Remscheid (DE); Heiko Klein, Remscheid (DE); Andreas Behrendt, Remscheid (DE)

(73) Assignee: Lear Corporation, Southfield, MI (US)

(21) Appl. No.: 18/417,009

(22) Filed: Jan. 19, 2024

(30) Foreign Application Priority Data
Jan. 20, 2023 (DE) 202023100299.4

(51) Int. Cl. H01R 13/453; H01R 11/28

(52) U.S. Cl. CPC H01R 13/453; H01R 11/281

(57) ABSTRACT

Electrical connectors with integrated touch protection are described. An example electrical connector has a conductor element, a fastening element that contacts the conductor element, a contact ring, an annular collar, and a protective sleeve. The protective sleeve fixed to the contact ring and partially covering the fastening element. The annular collar surrounding the contact ring. The annular collar and the protective sleeve form a touch protection that prevents unintentional contact of the contact ring and the fastening element.

### FIELD

The disclosure relates to electrical connectors with integrated touch protection. More specifically, the disclosure relates to electrical connectors with integrated touch protection for batteries of vehicles with an electric drive.

### BACKGROUND

Electrical connectors are generally used to make electrical connections in vehicles with an electrical drive system. The electric drive system of such vehicles is powered by energy storage devices, for example in the form of batteries or fuel cells. During the assembly and connection of energy storage devices, voltage may already be present at the connectors. To ensure occupational safety, electrical connectors are used that have touch protection for a human finger or appropriately standardized test fingers. Touch protection IPxxB is usually provided in accordance with ISO 20653 (version 02/2013). However, current electrical connectors that have touch protection require a high degree of manufacturing and assembly effort.

A need exists, therefore, for new and useful electrical connectors with touch protection.

### SUMMARY

Various electrical connectors with integrated touch protection are described.

An example electrical connector is a connector for a high-voltage clamping system. The electrical connector is designed for mechanical and electrical connection to a corresponding connector. The electrical connector has at least one conductor element, in particular a busbar, at least one fastening element, at least one contact ring, at least one annular collar and at least one protective sleeve. The annular collar is arranged to surround the contact ring. The annular collar and the protective sleeve together form a touch protection in order to prevent unintentional contact with the contact ring and the fastening element, in particular during assembly or disassembly. In an example, the protective sleeve is fixed to the contact ring. An electrical connector with touch protection is provided in which the effort for manufacturing and assembly is reduced and, at the same time, reliable touch protection is ensured.

In an embodiment, the electrical connectors described herein are part of an electrical interconnection system having a first electrical connector and a second, corresponding electrical connector that are mateable to form a mechanical and electrical connection. In these embodiments, the electrical connector has an integrated touch protection. In particular, the connector meets the requirements for contact protection IPxxB in accordance with the ISO 20653 standard (version 02/2013). The electrical connector comprises at least one conductor element. The conductor element is made of a material having electrical conductivity, for example copper. The conductor element is, for example, a bus bar. The conductor element can have any shape and is used, for example, for connection to an electrical component of a vehicle, for example an energy storage device or a consumer, e.g., an electric motor.

In an embodiment, the electrical connector further comprises at least one fastening element. The fastening element is connected to the conductor element. The fastening element serves to mechanically connect the electrical connector to a corresponding electrical connector, in particular the corresponding fastening element of the further connector. The fastening element has at least one fastening means, for example a thread, a clamp fastener, a bayonet fastener or a comparable, releasable fastening means, in order to be mechanically connected to a corresponding fastening element. The fastening means is preferably accessible from a direction oriented orthogonally to a surface of the conductor element.

In an embodiment, the fastening element is designed as a bolt with a central recess, with an internal thread being arranged in the central recess. The internal thread is designed to cooperate with an external thread of a corresponding fastening element. The fastening element preferably has at least two regions with different external diameters in its extension. The diameter increases starting from an end region facing away from the conductor element. In an embodiment, the fastening element is made of steel or another stable material, for example. The fastening element is mechanically connected to the conductor element in such a way that it protrudes at least partially from a surface of the conductor element. In an embodiment, the fastening element is surrounded by the contact ring over at least part of its height, for example the height projecting from the conductor element.

The contact ring makes electrically conductive contact with the conductor element and, when assembled with a corresponding connector, serves to establish the electrical connection between the two conductor elements to be connected. The contact ring is made of a material with electrical conductivity, for example copper. The fastening element and the contact ring are arranged on the conductor element in such a way that when a mechanical connection is made between two connectors with the fastening element, an electrical connection is simultaneously formed via the contact ring or contact rings.

In an embodiment, the electrical connector further comprises at least one annular collar and at least one protective sleeve. The annular collar, the protective sleeve and/or a conductor insulation are made of an electrically insulating material, such as an electrically insulating plastic. The plastic is, for example, polyoxymethylene (POM), polypropylene carbonate (PPC), polyamide (PA), polypropylene (PP), or a thermoplastic elastomer.

The annular collar surrounds the contact ring with a radial clearance which is dimensioned such that a human finger, in particular a standardized test finger, cannot penetrate the annular gap formed between the annular collar and the protective sleeve, thus preventing contact with the contact ring. The annular collar extends further or higher than the contact ring in an axial direction. For example, the annular collar and the protective sleeve have the same axial extension and thus the same height with respect to the conductor element. Alternatively, the protective sleeve can have a higher axial extension than the annular collar. In an embodiment, the annular collar is formed integrally with an electrical conductor insulation which at least partially surrounds the conductor element. In an embodiment, the conductor insulation is formed of a plastic material, for example, and/or is formed in two parts together with the annular collar and latched to the conductor element. Alternatively, in an embodiment, the annular collar is attached to the conductor insulation of the conductor element as a separate part.

The protective sleeve is arranged in such a way that it is located essentially centrally within the annular collar. The annular collar and the protective sleeve thus form a touch protection to prevent unintentional contact of the contact ring and the fastening element. The protective sleeve covers the fastening element in such a way that the fastening element cannot be touched by a human finger, in particular not by a test finger. In an embodiment, the protective sleeve has a sleeve-shaped base body in which a central recess is arranged. The fastening element extends at least partially in the recess and the fastening means of the fastening element, for example an internal thread, is accessible through the recess. To prevent contact with the fastening element located in the recess, the inner diameter of the protective sleeve is smaller than the diameter of a standardized test finger. A standardized test finger usually has a diameter of about 12.5 mm and a length of 80 mm. Furthermore, in an embodiment, the protective sleeve can extend beyond the fastening element, whereby an axial distance is realized between an end face of the protective sleeve and an end face of the fastening element.

In an embodiment, the protective sleeve is fixed to the contact ring. The protective sleeve is fixed to the contact ring in such a way that it is reliably held in position to ensure touch protection. For example, in an embodiment, the protective sleeve is arranged coaxially with respect to the fastening element and surrounds the fastening element circumferentially over at least part of the height of the fastening element. The fastening element extends, for example, at least partially within the protective sleeve. The protective sleeve is, for example, fixed or fastened to the contact ring in at least one of a force-fitting, a form-fitting, or material-fitting manner. The protective sleeve, therefore, reliably covers the fastening element against contact, but at the same time is held on the contact ring, which simplifies assembly.

In an embodiment of the connector, the protective sleeve comprises at least one radially outwardly projecting projection that interacts with the contact ring to hold the protective sleeve on the contact ring. For example, the projection is formed as a radially outwardly projecting shoulder. The shoulder fully surrounds the protective sleeve. Alternatively, the shoulder can have at least one interruption or a plurality of interruptions. In an embodiment, the projection is formed on an axial end of the protective sleeve facing the conductor element. The projection interacts with the contact ring in at least one of a form-fitting or a force-fitting manner in order to hold the protective sleeve on the contact ring. For example, the contact ring can have at least one groove, and that the projection engages in the groove to hold the protective sleeve on the contact ring. For example, the groove is formed on or in a recess of the contact ring. Alternatively or additionally, the contact ring can have at least one abutment, and that the projection interacts with the abutment, for example a shoulder in a recess, in order to hold the protective sleeve on the contact ring in a form-fitting and/or force-fitting manner.

To further simplify assembly, according to another embodiment of the connector, the protective sleeve has at least one radially elastic latching arm, and the projection is formed on the latching arm. In particular, if the projection interacts with a groove formed on the contact ring, the latching arm together with the projection can deflect radially inwards during assembly, in the direction of a central axis of the protective sleeve, in order to enable assembly. In an embodiment, the protective sleeve is provided with at least two, at least three, or at least four latching arms each having a projection. In these embodiments, the latching arms are evenly distributed over the circumference of the protective sleeve.

According to another embodiment of the connector, the contact ring has at least one recess with at least one abutment, and the projection bears against the abutment. The recess has, for example, at least one diameter reduction which forms at least one shoulder. The shoulder advantageously serves as an abutment. The projection, which is likewise formed as a circumferential shoulder, for example, is then in full contact with the abutment. This ensures form-fitting cooperation between the protective sleeve and the contact ring.

During assembly, the protective sleeve is inserted through the recess into the contact ring until the projection rests against the abutment. Subsequently, from the same assembly direction, the fastening element is at least partially inserted into the contact ring and fastened in order to fix the protective sleeve in the contact ring.

According to another embodiment, the projection of the protective sleeve, in particular the circumferential shoulder, is held in the recess of the contact ring between the abutment of the contact ring and an abutment shoulder of the fastening element. In the axial direction along its central axis, the protective sleeve with its radially outwardly projecting projection is thereby held in both directions between the contact ring and the fastening element. In the radial direction, the protective sleeve is also positioned between the fastening element and the contact ring. The abutment shoulder of the fastening element is formed, for example, between two sections with different diameters. For example, a section of the fastening element with a smaller diameter extends inside the protective sleeve.

According to another embodiment of the connector, the protective sleeve extends at least partially in the recess. In this embodiment, the protective sleeve is circumferentially closed, as is the radially outwardly projecting projection or circumferential shoulder provided on a first end face. Due to the fact that the protective sleeve extends at least partially in the recess, the protective sleeve can be fixed in the radial and axial direction between the contact ring and the fastening element.

In another embodiment, and to further simplify the assembly of the connector, the protective sleeve is formed at least in two parts and the protective sleeve is fastened to the contact ring by joining at least one first part and at least one second part. The protective sleeve is fastened in a form-fitting manner to the contact ring by joining the first part and the second part. The two-part nature of the protective sleeve simplifies production since no undercuts have to be demolded. The two parts of the protective sleeve can be manufactured independently of each other and latched together during assembly on the contact ring to secure the protective sleeve to the contact ring.

In order to ensure touch protection, according to a further embodiment of the connector, the protective sleeve extends in the axial direction beyond the fastening element. The fastening element is arranged at least partially within the protective sleeve. The protective sleeve extends further away from the conductor element than the fastening element.

In order to ensure stability of the protective sleeve in its free end region, according to a further embodiment, the protective sleeve has at least one ring portion projecting radially inwards, and the ring portion is arranged at a distance from an end face of the fastening element. The ring portion is arranged on a first end side of the protective sleeve facing away from the conductor element. In particular, the ring portion and the end face are arranged on one side of the conductor element. By arranging the ring portion at a distance from the end face of the fastening element, it can be ensured that no contact with the fastening element can occur by a user. In addition, the ring portion ensures stability of the protective sleeve, in particular against impact-type effects. The distance between an inner surface of the ring portion and an end face of the fastening element is at least about ⅕, or at least about ¼, or about ½ of the height of the protective sleeve.

According to another embodiment, the fastening element has a reduced or decreasing diameter in at least a first end region. The end region having a reduced or reducing diameter is the end region located inside the protective sleeve. Due to the reduced diameter in the end region or the diameter reducing (e.g., continuously), the assembly is simplified since the fastening element can be inserted more easily into the protective sleeve due to the tapered end region.

In order to be able to fasten the fastening element to the conductor element, according to another embodiment, the fastening element has at least one flange, and that the flange bears against the conductor element. For example, the fastening element is placed with the flange on the conductor element and connected thereto, for example by welding. The flange increases the contact area between the conductor element and the fastening element.

In another embodiment of the connector, the conductor element has at least one conductor recess, and that the fastening element is arranged to pass through the conductor recess and bears against the conductor element with the flange. The diameter of the flange is larger than the diameter of the conductor recess. The fastening element is guided almost completely through the conductor recess and rests with the flange arranged at the end against the conductor element from the opposite side. In this embodiment, the fastening element cannot detach from the conductor element even under a strong tensile load.

In another embodiment, the fastening element is connected to at least one of the conductor element or the contact ring in at least one of a form-fitting, a force-fitting, or a material-fitting manner, for example by pressing and/or welding. The fastening element passes through the conductor element in the conductor recess and is connected to the contact ring on the opposite side. As a result, the conductor element is clamped between the flange of the fastening element and the contact ring, so that the contact ring and fastening element are fixed to the conductor element. Alternatively, however, the fastening element is attached to both the conductor element and the contact ring. For example, the fastening element is pressed and/or welded to both the contact ring and the conductor element.

According to another embodiment, the fastening element has outwardly projecting ribs over at least part of its height, and the fastening element is pressed with the ribs to the conductor element and/or to the contact ring. The outer diameter of the ribs is slightly larger than the inner diameter of the recess of the conductor element and/or the recess of the contact ring. When the fastening element is pressed with force through the conductor recess in the conductor element into the recess of the contact ring, the ribs deform or press into the surfaces of the conductor element or contact ring, producing a form-fitting and force-fitting connection between the fastening element, the conductor element, and the contact ring. The fastening element is consequently pressed together with the contact ring and the conductor element. Starting from the flange, for example, the fastening element has a first section with a first diameter in which the ribs are arranged. This is followed by a second section with a second, smaller diameter. Between the first section and the second section, the abutment shoulder is formed. The second section can be arranged in the recess of the protective sleeve. At the end region of the second section facing away from the flange, the diameter tapers again to simplify assembly by insertion into the protective sleeve and the contact ring.

In an embodiment, an electrical connector comprises at least one conductor element, at least one fastening element, at least one contact ring, at least one annular collar, and at least one protective sleeve. The annular collar surrounds the contact ring. The annular collar and the protective sleeve form a touch protection to prevent unintentional contact of the contact ring and the fastening element. The protective sleeve has at least one radially inwardly projecting annular portion, and in that the annular portion is spaced from an end face or end surface of the fastener.

Additional understanding of these examples can be obtained by review of the detailed description, below, and the appended drawings.

### BRIEF DESCRIPTION OF THE DRAWINGS

FIG. 1 is a perspective view of an embodiment of an electrical connector with integrated touch protection.

FIG. 2 is a sectional view of the connector shown in FIG. 1.

FIG. 3a is a perspective view of an embodiment of a fastening element.

FIG. 3b is a perspective view of an embodiment of a contact ring.

FIG. 3c is a perspective view of an embodiment of a protective sleeve.

FIG. 3d is a perspective view of an embodiment of a conductor element.

FIG. 3e is a perspective view of an embodiment of a first part of a conductor insulation.

FIG. 3f is a perspective view of an embodiment of a second part of a conductor insulation.

### DETAILED DESCRIPTION

The following detailed description and the appended drawings describe and illustrate various example embodiments of electrical connectors with integrated touch protection. The description and illustration of these examples are provided to enable one skilled in the art to make and use an electrical connector that has integrated touch protection. They are not intended to limit the scope of the claims in any manner. The invention is capable of being practiced or carried out in various ways and the examples described and illustrated herein are merely selected examples of the various ways of practicing or carrying out the invention and are not considered exhaustive.

In the various figures, the same parts are given the same reference signs.

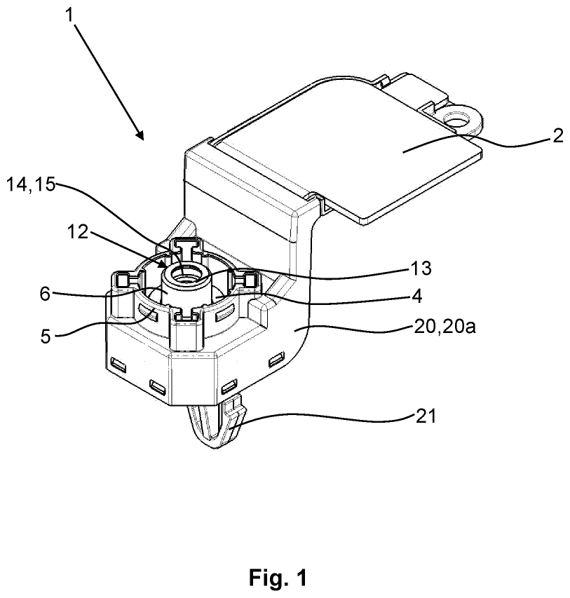

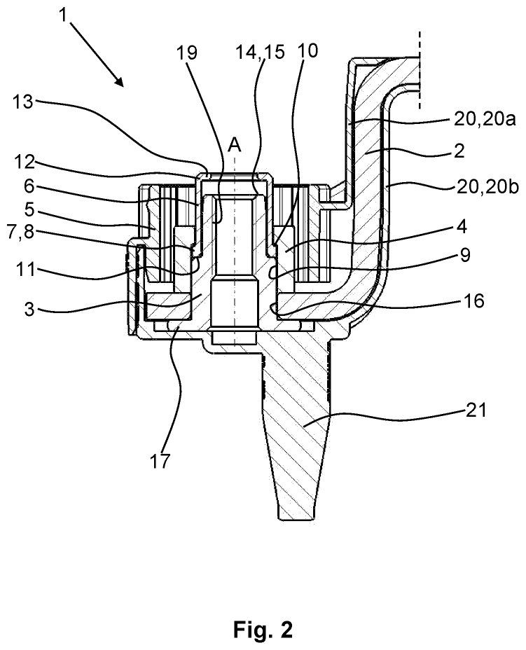

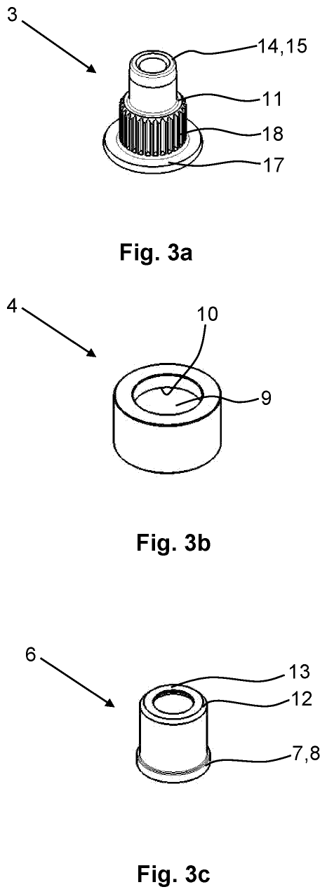

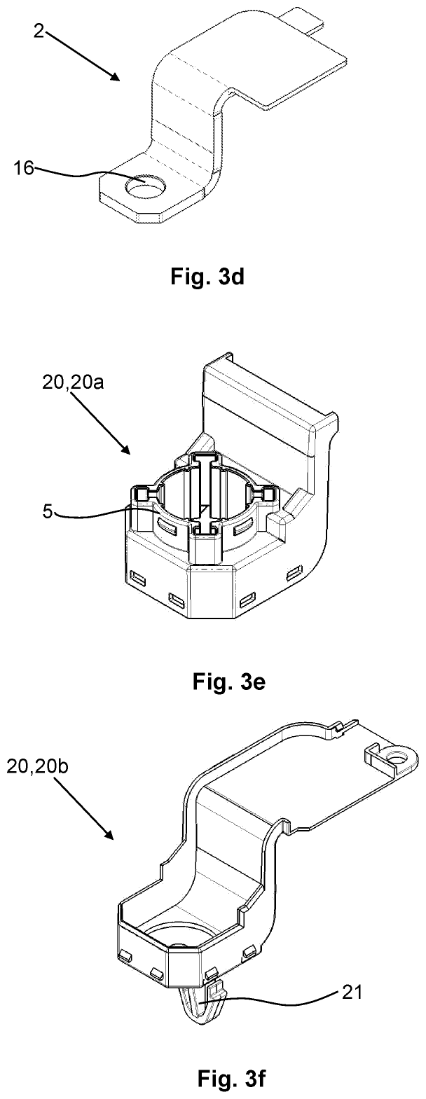

FIGS. 1 and 2 show a connector 1 in the assembled state. FIG. 2 is a sectional view in the area of the center axis A of the protective sleeve 6 or the fastening element 3. In FIG. 3a to FIG. 3f, the individual parts of the connector 1 are each shown in perspective view.

The connector 1 according to the embodiment depicted in the drawings has a conductor element 2 in the form of a busbar. The conductor element 2 is used to connect the electrical connector 1 to an electrical consumer or a voltage source. For this purpose, the conductor element 2 can be connected to an electrical component, such as a vehicle. In the illustrated embodiment, the conductor element 2 is made of copper and is bent in a step-shaped manner. However, alternative embodiments can include a conductor element formed of any suitable electrically conductive material and having any suitable shape.

The electrical connector 1 has a fastening element 3. In this embodiment, the fastening element 3 is designed as a bolt with an internal thread 19 as a fastening means for mechanically connecting the connector 1. The fastening element 3 is at least partially surrounded by a contact ring 4 and an annular collar 5. The fastening element 3 contacts the conductor element 2. The protective sleeve 6 is arranged centrally within the annular collar 5.

The annular collar 5 and the protective sleeve 6 are made of an electrically insulating material. In the embodiment shown, the annular collar 5 and the protective sleeve 6 are made of a plastic. However, any suitable electrically insulating material can be used. The annular collar 5 and the protective sleeve 6 together form a touch protection to prevent unintentional contact of the contact ring 4 and the fastening element 3 by a human finger or a standardized test finger. In this embodiment, the annular collar 5 is formed integrally with a conductor insulation 20 at least partially surrounding the conductor element 2. The conductor insulation 20 has at least one first part 20a and at least one second part 20b. The first part 20a and the second part 20b are interlocked with each other and completely surround the conductor element 2 in the areas where it is not to be contacted. The annular collar 5 is integrally formed with the first part 20a of the conductor insulation 20. A latch 21 is provided on the second part 20b of the conductor insulation 20b to secure the connector 1 to a mounting position.

The protective sleeve 6 is fixed to the contact ring 4. The protective sleeve 6 has a radially outwardly projecting projection 8 at a first end 7 facing the conductor element 2. The projection 8 is annular in shape and fully surrounds the protective sleeve 6. However, in alternative embodiments, a projection can partially surround a protective sleeve. The protective sleeve 6 partially covers the fastening element 3. The protective sleeve 6 extends at least partially in a recess 9 of the contact ring 4 and rests with the projection 8, in the axial direction along the central axis A, against an abutment 10 in the form of a circumferentially closed shoulder on the contact ring 4. As a result, the protective sleeve 6 is fixed to the contact ring 4, in the axial direction along the center axis A. The abutment 10 is formed by a change in diameter in the recess 9.

To mount the connector 1, the protective sleeve 6 is inserted from below into the recess 9 of the contact ring 4 until it emerges from the recess 9 at the top and rests with the projection 8 against the abutment 10. In order to completely fix the protective sleeve 6 in the axial direction along the center axis A, the fastening element 3 has an abutment shoulder 11, which is also formed between two areas of the fastening element 3 with different outer diameters. The protective sleeve 6 is held in a form-fitting manner in the axial direction along the center axis A with its projection 8 between the abutment 10 and the abutment shoulder 11.

The contact ring 4 is made of a material having electrical conductivity, such as copper. In addition to establishing the electrical connection, the contact ring 4 also serves to lock the protective sleeve 6. The protective sleeve 6 extends in the axial direction along the center axis A beyond the fastening element 3, in particular further away from the conductor element 2 than the fastening element 3. This prevents contact with the fastening element 3.

At its second end 12 facing away from the conductor element 2, the protective sleeve 6 has a radially inwardly projecting ring portion 13 which stabilizes the protective sleeve 6. The ring portion 13 is arranged in such a way, or the protective sleeve 6 is dimensioned in such a way, that ring portion 13 is arranged at a distance, in particular in the axial direction, from an end face 14 of the fastening element 3. The distance between the end face 14 of the fastening element 3 and an inner surface of the ring portion 13 facing the end face 14 can be any suitable distance. In the illustrated embodiment, the distance between the end face 14 of the fastening element 3 and an inner surface of the ring portion 13 facing the end face 14 is at least about ⅕ of the height of the protective sleeve 6. In alternative embodiments, however, the distance between an inner surface of a ring portion and an end face of a fastening element can be at least about ¼, or about ½ of the height of the protective sleeve.

The fastening element 3 has a tapering outer diameter in its first end region 15 facing away from the conductor element 2 in order to simplify insertion of the fastening element into the protective sleeve 6 during assembly. After the protective sleeve 6 has been inserted into the contact ring 4 from below during assembly, the fastening element 3 is subsequently inserted into the recess 9 of the contact ring 4 and fastened there. The fastening element 3 is connected to one of the conductor element 2 or the contact ring 4.

In the embodiment shown, the fastening element 3 has a flange 17 which rests against the conductor element 2 on a side of the conductor element 2 opposite the contact ring 4. For this purpose, the fastening element 3 is guided through a conductor passageway 16 through the conductor element 2 until the flange 17 rests against the conductor element 2.

For the fastening, the fastening element 3 has ribs 18 projecting outwards over part of its height (see in particular FIG. 3a), with which the fastening element 3 is pressed in a form-fitting and force-fitting manner in the conductor passageway 16 of the conductor element 2 and the recess 9 of the contact ring 4. The ribs 18 are at least partially deformed during assembly and/or penetrate the surface of the conductor passageway 16 or the recess 9.

The illustration of any component, element, or feature as being disposed above, below, left of, or right of another component, element, or feature is only with reference to the relative location of the components, elements, and features as shown in the figures in order to aid in describing an electrical connector. Accordingly, some of the components, elements, or features illustrated and described herein can be oriented in any manner desired without departing from the spirit or scope of the invention.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An electrical connector comprising:
a conductor element, a fastening element contacting the conductor element, a contact ring, an annular collar, and a protective sleeve fixed to the contact ring and partially covering the fastening element, the annular collar surrounding the contact ring, the annular collar and the protective sleeve forming a touch protection preventing unintentional contact of the contact ring and the fastening element.

2. The electrical connector of claim 1, wherein the protective sleeve has at least one radially outwardly projecting projection.

3. The electrical connector of claim 2, wherein the radially outwardly projecting projection interacts with the contact ring to hold the protective sleeve on the contact ring.

4. The electrical connector of claim 2, wherein the contact ring has at least one recess with an abutment; and
wherein the radially outwardly projecting projection bears against the abutment.

5. The electrical connector of claim 2, wherein the contact ring has a recess and an abutment;
wherein the fastening element has an abutment shoulder; and
wherein the radially outwardly projecting projection of the protective sleeve is held in the recess of the contact ring between the abutment of the contact ring and the abutment shoulder of the fastening element.

6. The electrical connector of claim 5, wherein the protective sleeve extends at least partially in the recess.

7. The electrical connector of claim 1, wherein the protective sleeve extends in an axial direction beyond the fastening element.

8. The electrical connector of claim 1, wherein the protective sleeve has at least one radially inwardly projecting ring portion; and
wherein the ring portion is arranged at a distance from an end face of the fastening element.

9. The electrical connector of claim 8, wherein the protective sleeve has a height; and
wherein the distance is at least about ⅕, or at least about ¼, or about ½ of the height of the protective sleeve.

10. The electrical connector of claim 1, wherein the fastening element has a decreasing diameter at least in a first end region.

11. The electrical connector of claim 1, wherein the fastening element has at least one flange; and
wherein the flange bears against the conductor element.

12. The electrical connector of claim 11, wherein the conductor element has a conductor passageway; and
wherein the fastening element passes through the conductor passageway and bears with the flange against the conductor element.

13. The electrical connector of claim 1, wherein the fastening element is connected to one of the conductor element or the contact ring.

14. The electrical connector of claim 1, wherein the fastening element is connected to one of the conductor element or the contact ring in at least one of a form-fitting, a force-fitting, or a material-fitting manner.

15. The electrical connector of claim 1, wherein the fastening element has a height and outwardly projecting ribs at least over part of the height; and
wherein the fastening element is pressed with the outwardly projecting ribs to at least one of the conductor element or the contact ring.

16. The electrical connector of claim 1, wherein the conductor element and the contact ring are made of an electrically conductive material.

17. The electrical connector of claim 16, wherein the annular collar and the protective sleeve are made of an electrically insulating material.

18. The electrical connector of claim 17, wherein the electrically conductive material is copper; and
wherein the electrically insulating material is plastic.

19. An electrical connector comprising:
a conductor element, a fastening element contacting the conductor element, a contact ring, an annular collar, and a protective sleeve fixed to the contact ring and partially covering the fastening element, the annular collar surrounding the contact ring, the annular collar and the protective sleeve forming a touch protection preventing unintentional contact of the contact ring and the fastening element;
the protective sleeve having at least one radially outwardly projecting projection interacting with the contact ring to hold the protective sleeve on the contact ring; and
the protective sleeve extending in an axial direction beyond the fastening element.

20. An electrical connector comprising:
a conductor element, a fastening element contacting the conductor element, a contact ring, an annular collar, and a protective sleeve fixed to the contact ring and partially covering the fastening element, the annular collar surrounding the contact ring, the annular collar and the protective sleeve forming a touch protection preventing unintentional contact of the contact ring and the fastening element;
the protective sleeve having at least one radially outwardly projecting projection interacting with the contact ring to hold the protective sleeve on the contact ring;
the protective sleeve extending in an axial direction beyond the fastening element;
the contact ring having at least one recess with an abutment;
the fastening element having an abutment shoulder; and
wherein the radially outwardly projecting projection of the protective sleeve is held in the recess of the contact ring between the abutment of the contact ring and the abutment shoulder of the fastening element.
